(19) United States
(12) Patent Application Publication
(10) Pub. No.: US 2015/0031142 A1
(43) Pub. Date: Jan. 29, 2015

(54) DEVICE AND METHOD FOR MEASURING GAS CHEMICAL SOLVENT ABSORPTION AND DESORPTION REACTION HEAT

(71) Applicants: Sinopec Petroleum Engineering Corporation, Dongying (CN); Shandong Seri Petrotech Development Co., Ltd, Dongying (CN); China University of Petroleum (Huadong), Qingdao (CN)

(72) Inventors: Jian Zhang, Dongying (CN); Qingfang Li, Dongying (CN); Haili Liu, Dongying (CN); Shijian Lu, Dongying (CN); Minghua Shang, Dongying (CN); Xin Wang, Qingdao (CN); Limin He, Qingdao (CN); Shaowei Huang, Dongying (CN); Xinjun Zhang, Dongying (CN); Guangling Sun, Dongying (CN); Tong Shan, Qingdao (CN); Zenglin Wang, Dongying (CN); Huizhong Pang, Dongying (CN); Dongjie Liu, Dongying (CN); Huijuan Yu, Dongying (CN); Zhiying Sun, Dongying (CN); Luning Wu, Dongying (CN); Hongbin Zhu, Dongying (CN); Ningning Zhang, Dongying (CN); Lei Zhang, Dongying (CN); Yinjun Lu, Dongying (CN)

(21) Appl. No.: 14/328,493

(22) Filed: Jul. 10, 2014

(30) Foreign Application Priority Data
Jul. 25, 2013 (CN) 201310313794.2

(51) Int. Cl. G01N 25/48; G01N 27/18

(52) U.S. Cl. CPC G01N 25/4893; G01N 25/4886; G01N 27/18
USPC 436/147; 422/51

(57) ABSTRACT

The present disclosure discloses a device and a method for measuring gas chemical solvent absorption and desorption reaction heat. The device comprises an outer casing; an metal guard inner shell; a reactor; a pressure sensor; a thermal insulation material between the outer casing and the metal guard inner shell; guard electric heaters provided respectively in an upper portion and a lower portion of an outer periphery of the metal guard inner shell; a glass fiber thermal insulation layer between the inner metal guard shell and the reactor; temperature thermocouples provided in the glass fiber thermal insulation layer; a glass fiber board provided in a lower portion of an outer periphery of the reactor; main electric heaters between the glass fiber board and the reactor; a liquid inlet pipe and a gas discharge pipe; a temperature thermistor, a liquid discharge pipe; a data acquisition board; a computer; and a power supply.

### CROSS-REFERENCE TO RELATED APPLICATIONS

The present application claims priority to Chinese Patent Application No. CN 201310313794.2 filed on Jul. 25, 2013, the content of which is fully incorporated in its entirety herein.

### FIELD OF THE PRESENT DISCLOSURE

The present disclosure relates to a device and a method for measuring reaction heat of gases, such as CO₂, H₂S or SO₂ and the like, generated in chemical solvent absorption and desorption reaction process, in which an adiabatic condition of a reaction system is achieved by precise control of electric heaters, and which can precisely measure a heat release amount in the absorption reaction process and a heat absorption amount in the desorption reaction process.

### BACKGROUND OF THE PRESENT DISCLOSURE

The chemical solvent absorption method is a method which is easy to implement large-scale industrial application in current natural gas acid gas purification industrial, coal-fired power plant flue gas CO₂ capture industrial, and the like, which has a broad prospect. However, the regeneration process of the chemical solvent after absorption requires consumption of a large amount of thermal energy, resulting in higher operating cost, and therefore, energy consumption characteristics of various chemical solvent formulations determine their possibility in economics. Therefore, an experimental evaluation method and an experimental evaluation device which can precisely measure gas absorption and desorption reaction heat must be provided in the chemical absorption solvent development and selection process.

Because the gas chemical absorption and desorption experiment requires the chemical solvent in a reactor having an appropriate volume (typically 0.2-2 liters) is performed and controlled at preset temperature and pressure parameters, and therefore, the calorimeter development is firstly to design a reactor which can easily adjust the state of the reaction, and then the reaction heat of the sample during material feeding reaction process or material discharging reaction process in the reactor is measured in real time. Because an electric heater is easy to install and control, the electric heater has more applications in reaction calorimetry. For example, U.S. patent document, the title of which is Micro-scale chemical process simulation methods and apparatus useful for design of full-scale processes, emergency relief systems and associated equipment, Patent No. of which is U.S. Pat. No. 4,670,404 issued on Jun. 2, 1987, discloses a method for controlling temperature difference between the sample in a micro (about 100 milliliters) reactor and a metal wall of an outer guard shell to be minimal with adoption of a peripheral guard electric heater to achieve the adiabatic condition of the reaction process, so as to simulate temperature and pressure changes of runaway exothermic reaction of a large-volume reactor, and provide guidance for the design of a safety system. But analysis shows that, in the method, when the electric heater outside the reactor heats the sample in the reactor, the temperature in an area where the electric heater is present rises and is greater than the temperature of the sample in the reactor, and is greater than the temperature of the outer guard shell, resulting in some heat dissipated toward the outside via heat conduction, a greater error will be caused when heat measurement is performed. In addition, when this patent technology is applied to the reactor having a large volume, if a large amount of heat is generated in the reactor when the exothermic reaction occurs to cause non-uniform distribution of the temperature of the solvent sample, the temperature of the wall surface of the reactor is smaller than the temperature of the center of the sample, at this time if the method which controls the temperature difference between the metal wall of the outer guard shell and the center of the sample to be minimal is still used, it will cause heat conducted toward the reactor, and bring an error in heat measurement.

With respect to the above-mentioned disadvantages of U.S. Pat. No. 4,670,404 which is applied to chemical reaction heat measurement in a large-volume reactor, a technical problem to be resolved by the present disclosure is to provide a manner suitable for controlling adiabatic condition of the reactor having a large volume, the adiabatic condition of the reactor can be maintained when the exothermic reaction occurs or endothermic reaction occurs in the reactor and electric heaters outside the reactor start heat compensation, so as to precisely measure reaction heat.

### SUMMARY OF THE PRESENT DISCLOSURE

An object of the present disclosure is to provide a device and a method for measuring gas chemical solvent absorption and desorption reaction heat, which can effectively simulate gas chemical absorption and desorption reaction process in the large-volume reactor, and temperature and pressure state parameters of the reactor can be controlled and preset according to requirements. With precisely controlling peripheral guard electric heaters and main electric heaters outside the reactor, the present disclosure realize the adiabatic condition of the chemical reaction system so as to precisely measure a heat release amount in the gas absorption reaction phase and a heat absorption amount in the gas desorption reaction phase.

The present disclosure provides a device for measuring gas chemical solvent absorption and desorption reaction heat, which comprises: an outer casing; a metal guard inner shell; a reactor provided in a middle portion of the metal guard inner shell; a pressure sensor; a thermal insulation material provided between the outer casing and the metal guard inner shell; a group of guard electric heaters H_{GU} and a group of guard electric heaters H_{GL} provided respectively in an upper portion and a lower portion of an outer periphery of the metal guard inner shell; a glass fiber thermal insulation layer provided between the metal guard inner shell and the reactor; temperature thermocouples provided in the glass fiber thermal insulation layer; a glass fiber board provided in a lower portion of an outer periphery of the reactor; main electric heaters H_{R} provided between the glass fiber board and the reactor; a magnetic stirring bar provided above a bottom portion of the reactor; a magnetic stirring apparatus provided at an outer side of a bottom portion of the outer casing; a liquid inlet pipe and a gas discharge pipe extending from an upper portion of the reactor toward a top portion of the outer casing; a temperature thermistor and a liquid discharge pipe extending from above the bottom portion of the reactor toward the top portion of the outer casing; a data acquisition board connected with signal wires of the pressure sensor, the temperature thermocouples inside the metal guard inner shell and outside the reactor in the glass fiber thermal insulation layer, the temperature thermistor extending into the reactor, and the temperature thermocouples in the glass fiber board; a computer connected with the data acquisition board; and a power supply connected with the guard electric heaters outside the metal guard inner shell and the main electric heaters H_{R} outside the reactor.

In an embodiment of the present disclosure, a gas inlet pipe is provided so that a segment of the gas inlet pipe outside the outer casing is provided with a ball valve and a self-operated pressure regulating valve is positioned in front of the ball valve.

In an embodiment of the present disclosure, a segment of the liquid inlet pipe outside the outer casing is provided with a right angle tee, a vertical segment of the right angle tee is provided with a liquid feeding port and a ball valve, a horizontal segment of the right angle tee is provided with a safety valve, a ball valve, a pressure gage and the pressure sensor.

In an embodiment of the present disclosure, a segment of the gas discharge pipe outside the outer casing is provided with a self-operated pressure regulating valve.

In an embodiment of the present disclosure, a segment of the liquid discharge pipe outside the outer casing is provided with a ball valve.

In an embodiment of the present disclosure, an area dividing line is defined between the guard electric heaters H_{GU} in the upper portion of the outer periphery of the metal guard inner shell and the guard electric heaters H_{GL} in the lower portion of the outer periphery of the metal guard inner shell, an area above the area dividing line is defined as a U area, an area below the area dividing line is defined as a L area.

The present disclosure further provides a method for measuring gas chemical solvent absorption and desorption reaction heat, which includes steps of: heating a sample solvent by main electric heaters H_{R} provided in a lower portion of an outer periphery of a reactor; measuring temperatures of a wall of the reactor by groups of temperature thermocouples uniformly distributed at an outer side of the wall of the reactor, averaging the temperatures of the wall positioned in a lower portion area outside the reactor and inside the main electric heaters H_{R} measured by the temperature thermocouples as T_{WL}, averaging the temperatures of the wall positioned in an upper portion area of the reactor as T_{WU}, uniformly providing a group of temperature thermocouples at a distance of 1-5 mm from the outer side of the main electric heaters H_{R} and averaging temperatures measured by the group of temperature thermocouples as T_{IN}, filling a glass fiber board between the group of temperature thermocouples and the main electric heaters H_{R}; placing the assembly of the reactor and the main electric heaters H_{R} in a metal guard inner shell filled with a glass fiber thermal insulation layer; providing an upper group of guard electric heaters H_{GU} and a lower group of guard electric heaters H_{GL} at positions on an outer surface of a wall of the metal guard inner shell corresponding to the main electric heaters H_{R} for the reactor, at the same time uniformly providing an upper group of temperature thermocouples and a lower group of temperature thermocouples at positions on an inner surface of the wall of the metal guard inner shell respectively corresponding to the upper group of guard electric heaters and the lower group of guard electric heaters, averaging temperatures measured by the upper group of temperature thermocouples as T_{GU} and averaging temperatures measured by the lower group of temperature thermocouples as T_{GL}; powering the main electric heaters H_{R} and the guard electric heaters H_{GU} and H_{GL} by a power supply, and measuring and adjusting heating powers of the main electric heaters and the guard electric heaters by a computer; placing the above assembly into an outer casing filled with a thermal insulation material, controlling that the temperature of the outer surface of the wall of the metal guard inner shell is equal to the temperature of the outer surface of the wall of the reactor or the temperature of the a glass fiber board outside the main electric heaters H_{R} with a program, maintaining an adiabatic condition of the reactor when the exothermic reaction occurs or endothermic reaction occurs and the main electric heaters H_{R} start in the experiment, and then calculating heat release amount or heat absorption amount of the reaction according to an internal energy change measured by experimental calibration and a Joule heat of the main electric heaters H_{R}

When the gas absorption experiment is performed, the guard electric heaters H_{GU} and the guard electric heaters H_{GL} are firstly started, the guard electric heaters H_{GU} and the guard electric heaters H_{GL} are respectively controlled with a program in the computer and the temperature thermocouples to allow T_{GU} and T_{GL} to respectively trace and be respectively equal to T_{WU} and T_{IN}, the adiabatic condition of the reactor is maintained. The program can be adjusted by adoption of algorithm such as PID (Proportion Integration Differentiation), proportion, integration and differentiation parameters can be set in advance according to the sample quality and quantity. The main electric heaters H_{R} outside the reactor are started, the main electric heaters H_{R} are controlled with the program in the computer and the temperature thermocouples to allow the temperature of the absorption liquid to rise to a preset temperature T_{S1} from temperature T_{S0}, a small amount of the gas will be absorbed in this process. Then the main electric heaters H_{R} are turned off, the guard electric heaters H_{GL} are controlled to switch and change the average temperature of the inner side of the metal guard inner shell in the L area, T_{GL}, to trace and be equal to the average temperature of the outer side of the reactor in L area, T_{WL}. The magnetic stirring apparatus is started and gas absorption exothermic reaction extensively starts, and the pressure of the reactor is maintained constant. Because the exothermic reaction occurs, the temperature of the absorption liquid in the reactor rises. When the temperature of the absorption liquid rises to T_{S2} and maintains constant, in combination with flow change of gas injected into the reactor, the absorption reaction can be judged as ending, the ball valve is switched off. After the experiment ends, the heat release amount of the absorption reaction is calculated according to an internal energy change of the reaction system from T_{S0} to T_{S2} and an input thermal energy change of the main electric heaters H_{R}. And the internal energy change can be determined by performing the same temperature rising process experiment without chemical reaction with adoption of the sample of the same quality and quantity, the input thermal energy of the main electric heaters H_{R} can be determined according to the Joule heat of the main electric heaters H_{R}.

When the gas desorption experiment is performed, the guard electric heaters H_{GU} and the guard electric heaters H_{GL} maintain on-state, the guard electric heaters H_{GU} and the guard electric heaters H_{GL} are respectively controlled with the program in the computer and the temperature thermocouples to allow T_{GU} and T_{GL} to respectively trace and be respectively equal to T_{WU} and T_{WL}. At this time, the self-operated pressure regulating valve at the gas outlet of the reactor controls the reactor at a preset pressure in the gas desorption experiment, at the same time, the guard electric heaters H_{GL} are controlled to switch T_{GL} to trace and be equal to T_{IN}. And then, the main electric heaters H_{R} are started, the main electric heaters H_{R} are controlled with the program in the computer and temperature thermocouples to allow the temperature of the absorption liquid to rise to a preset temperature T_{S3} from T_{S2} (the desorption reaction generates a small amount of gas in this process). The temperature of the absorption liquid in the reactor is lowered, and at this time, the heating power of the main electric heaters H_{R} is automatically controlled with the program in the computer and temperature thermocouples to maintain the temperature of the absorption liquid at the temperature T_{S3}. The magnetic stirring apparatus is started, to allow gas desorption endothermic reaction to extensively start, the pressure and temperature of the reactor maintain constant. When the heating power of the main electric heaters H_{R} is zero, in combination with flow change of gas discharged out from the reactor, the desorption reaction can be judged as ending. After the experiment ends, the heat absorption amount of the desorption reaction is calculated according to an internal energy change of the reaction system from T_{S2} to T_{S3} and an input thermal energy of the main electric heaters H_{R}. Similarly, the internal energy change can be determined by performing the same temperature rising process experiment without chemical reaction with adoption of the sample of the same quality and quantity, the input thermal energy of the main electric heaters H_{R} can be determined according to the Joule heat of the main electric heaters H_{R}.

The present disclosure is suitable for gas chemical solvent absorption and desorption selection experiment and reaction heat measurement of the large-volume reactor, compared with the prior art, the experiment precision can be significantly improved, the gas absorption and desorption experiments are easily performed. The sample temperature can be controlled to rise in step manner and the adiabatic condition can be maintained during the experiment, so as to determine the starting temperature point of the gas absorption reaction or desorption reaction. Measurement error of the experiment system can be tested and corrected by a standard media experiment.

### BRIEF DESCRIPTION OF THE FIGURES

FIG. 1 is a cross-sectional view of a structure of a reactor of the present disclosure;

FIG. 2 is a schematic diagram of an overall system of the present disclosure;

FIG. 3 is a flowchart of logic controls of heaters and other devices in a gas absorption reaction process of the present disclosure;

FIG. 4 is a flowchart of logic controls of heaters and other devices in a gas desorption reaction process of the present disclosure.

Reference numerals are represented as follows:

1—outer casing

2—thermal insulation material

3—metal guard inner shell

4—temperature thermocouple

5—glass fiber thermal insulation layer

6—absorption liquid level

7—main electric heater H_{R}

8—area dividing line

9—glass fiber board

10—reactor

11—magnetic stirring bar

12—magnetic stirring apparatus

13—guard electric heater H_{GU}

14—guard electric heater H_{GL}

15—ball valve

16—self-operated pressure regulating valve

17—liquid feeding port

18—ball valve

19—temperature thermistor for Ts

20—gas discharge pipe

21—liquid discharge pipe

22—safety valve

23—pressure gage

24—pressure sensor

25—liquid inlet pipe

26—gas inlet pipe

27—self-operated pressure regulating valve

28—ball valve

29—signal wire of pressure sensor

30—signal wire of temperature thermocouple at inner side of metal guard inner shell in U

area for T_{GU}

31—signal wire of temperature thermocouple at outer side of reactor in U area for T_{WU}

32—signal wire of temperature thermistor

33—signal wire of temperature thermocouple at inner side of metal guard inner shell in L area T_{GL}

34—signal wire of temperature thermocouple at glass fiber board for T_{IN}

35—signal wire of temperature thermocouple at outer side of reactor in L area for T_{WL}

36—reactor apparatus schematic diagram

37—power supply

38—connection cable

39—data acquisition board

40—computer

### DETAILED DESCRIPTION

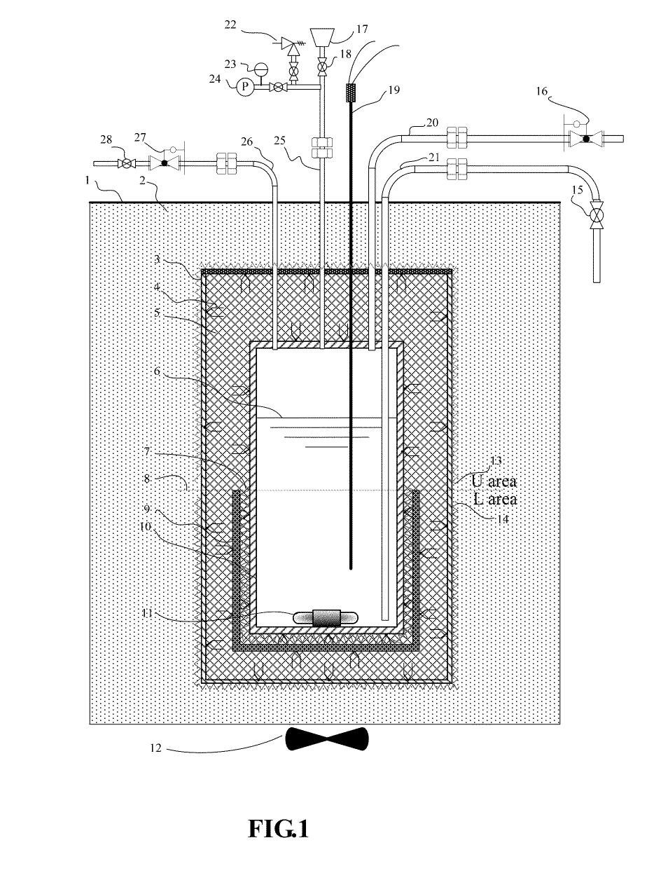

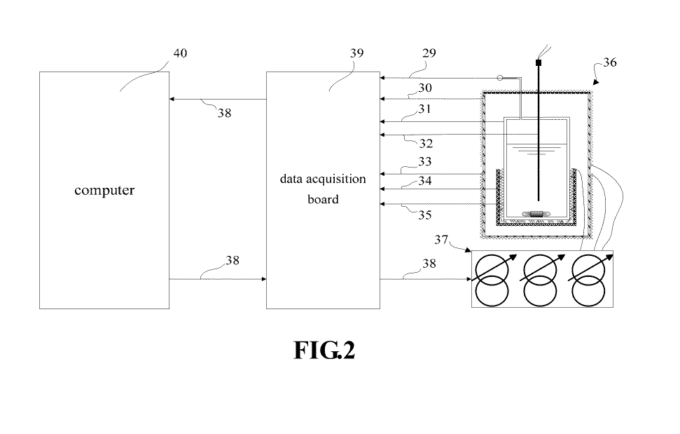

Referring to FIG. 1 and FIG. 2, a device for measuring gas chemical solvent absorption and desorption reaction heat of the present disclosure comprises an outer casing 1, a metal guard inner shell 3 provided in the outer casing 1 and a thermal insulation material 2 filled between the metal guard inner shell 3 and the outer casing 1. An area dividing line 8 divides FIG. 1 into two areas, i.e. a U area and a L area representing an upper area and a lower area respectively. Guard electric heaters H_{GU} 13 are distributed at an outer side of the metal guard inner shell 3 in the U area, and guard electric heaters H_{GL} 14 are distributed at the outer side of the guard inner shell 3 in the L area. A plurality of groups of temperature thermocouples 4 are uniformly distributed at an inner side of the metal guard inner shell 3, and an average temperature of the inner side of the metal guard inner shell 3 in the U area measured by the temperature thermocouples 4 at the inner side of the metal guard inner shell 3 in the U area, which is transferred by a signal wire 30, is recorded as T_{GU}, an average temperature of the inner side of the metal guard inner shell 3 in the L area measured by the temperature thermocouples 4 at the inner side of the metal guard inner shell 3 in the L area ,which is transferred by a signal wire 33, is recorded as T_{GL}. A glass fiber thermal insulation layer 5 is filled between the metal guard inner shell 3 and the reactor 10, and main electric heaters H_{R} 7 are distributed at an outer side of the reactor 10 in the L area, and an outer side of the main electric heaters H_{R} 7 is covered with a glass fiber board 9 having a certain thickness. An average temperature of the outer side of the reactor 10 in the U area measured by the temperature thermocouples 4 at the outer side of the reactor 10 in the U area, which is transferred by a signal wire 31, is recorded as T_{WU}, an average temperature of the outer side of the reactor 10 in the L area measured by the temperature thermocouples 4 at the outer side of the reactor 10 in the L area, which is transferred by a signal wire 35, is recorded as T_{WL}. A plurality of groups of temperature thermocouples 4 are uniformly distributed at the outer side of the glass fiber board 9 in the L area, an average temperature of the glass fiber board 9 measured by the temperature thermocouples 4 at the outer side of the glass fiber board 9 in the L area, which is transferred by a signal wire 34, is recorded as T_{IN}. Heating powers of the main electric heaters H_{R} 7, the guard electric heaters H_{GL} 13 and the guard electric heaters H_{GU} 14 are all provided by the power supply 37 of DC or AC. A magnetic stirring apparatus 12 positioned outside drives a magnetic stirring bar 11 positioned at a bottom portion of the reactor 10 to rotate. Four pipes connected to a top portion of the reactor 10 are a gas inlet pipe 26, a liquid inlet pipe 25, a gas discharge pipe 20 and a liquid discharge pipe 21, respectively, and at the same time, a temperature thermistor 19 is inserted into an absorption liquid, the temperature measured by the temperature thermistor 19, which is transferred by a signal wire 32, is recorded as T_{S}.

As shown in FIG. 1, the temperature required for the adiabatic condition of the experiment in the present disclosure is controlled and measured by means of the divided areas, and the plurality of groups of temperature thermocouples 4 are uniformly distributed at the inner side of the metal guard inner shell 3 covered by the guard electric heaters H_{GU} 13 and the guard electric heaters H_{GL} 14 and at outer side of the reactor 10 to measure and calculate the temperature average values, achieving corresponding tracing control on the temperatures in different areas, so as to reduce experimental error, and ensure the adiabatic condition. Of course, it can also be divided into a plurality of areas for performing temperature controls so as to further improve the precision. The glass fiber board 9 is provided between the metal guard inner shell 3 and the main electric heaters H_{R} 7, with temperature thermocouples 4 uniformly distributed at the outer side of the glass fiber board 9, the measured average temperature of the glass fiber board 9, T_{IN}, or the average temperature of the outer side of the reactor 10 in the L area, T_{WL}, are selected to trace the average temperature of the inner side of the metal guard inner shell 3 in L area, T_{GL}, according to whether the main electric heaters H_{R} 7 are started or turned off. The internal energy change generated by the temperature change of the reaction system can be experimentally determined by performing the same temperature rising process without chemical reaction with adoption of the sample of the same quality and quantity, the input thermal energy of the main electric heaters H_{R} 7 is determined according to the Joule heat of the main electric heaters H_{R} 7.

Next, principles of the present disclosure are further described.

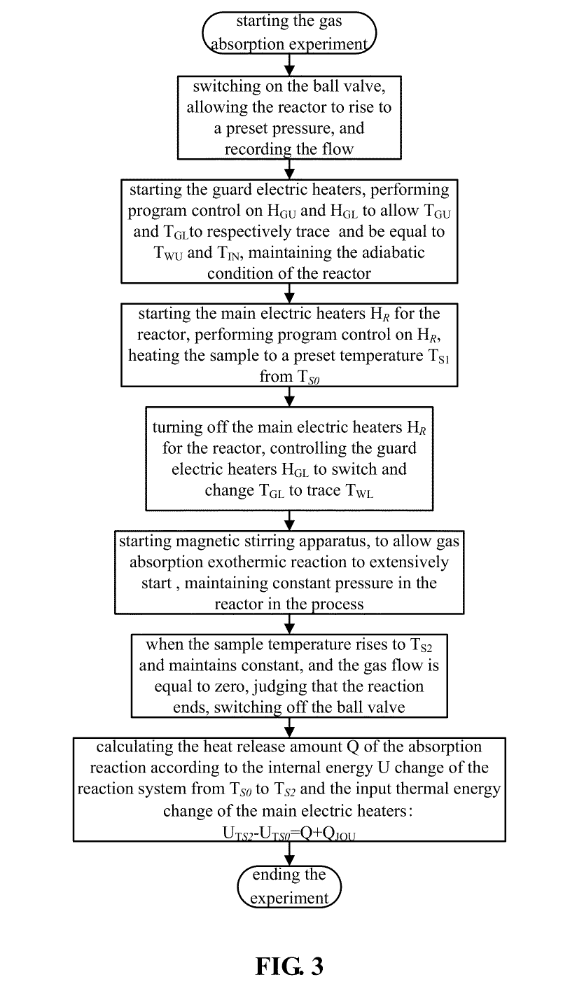

When the gas absorption experiment is performed, as shown in FIG. 3, nitrogen is injected into the reactor 10 and each of the pipes 20,21,25,26 to purge, a certain amount of the absorption liquid is injected from the liquid feeding port 17, and then ball valve 18 is switched off. The ball valve 15 on the liquid discharge pipe 21 is switched off, the ball valve 28 is switched on, a gas is continuously injected. The guard electric heaters H_{GU} 13 and the guard electric heaters H_{GL} 14 are started, T_{GU} and T_{GL} respectively trace and are respectively equal to T_{WU} and T_{IN}. The main electric heaters H_{R} 7 are started, the temperature of absorption liquid measured by the temperature thermistor 19 rises to a preset temperature T_{S0}. The main electric heaters H_{R} 7 are turned off, the guard electric heaters H_{GL} 14 are controlled to switch and change the average temperature of the inner side of the metal guard inner shell 10 in the L area, T_{GL}, to trace and be equal to the average temperature of the outer side of the reactor 10 in L area, T_{WL}. The self-operated pressure regulating valve 27 is switched on to allow a pressure of the reactor 10 measured by a pressure sensor 24 at a preset value. The magnetic stirring apparatus 12 is started to drive the magnetic stirring bar 11 to rotate at a preset speed to allow complete absorption of the gas. When the temperature of the absorption liquid measured by the temperature thermistor 19, T_{S2}, substantially maintains constant and the gas injected flow is zero, the absorption reaction is deemed as ending, the ball valve 28 is switched off. The heat release amount Q of the absorption reaction is calculated according to an internal energy U change of the same reagents with experimental calibration in advance from reaction temperature T_{S0} to T_{S2} and the input thermal energy Q_{JOU} of the main electric heaters H_{R} 7:

U_{TS2}−U_{TS0}=Q+Q_{JOU}

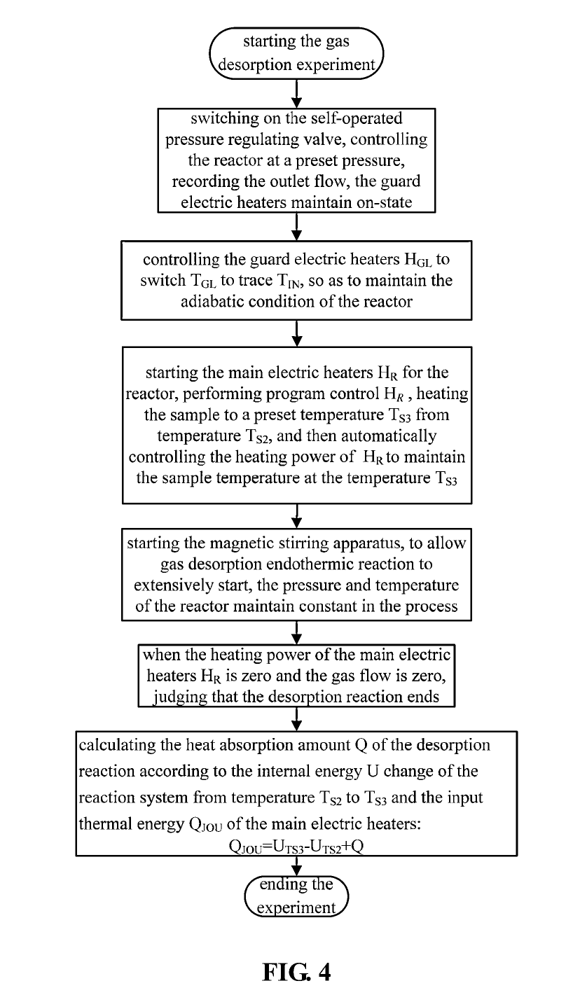

When the gas desorption experiment is performed, as shown in FIG. 4, the guard electric heaters H_{GU} 13 and the guard electric heaters H_{GL} 14 are continuously switched on, the self-operated pressure regulating valve 16 on the gas discharge pipe 20 is switched onto set a pressure, so as to ensure the pressure in the reactor 10 constant, T_{GL} is switched to trace and be equal to T_{IN}. The main electric heaters H_{R} 7 are started, the heating power of the main electric heaters H_{R} 7 are controlled to allow the temperature of the absorption liquid to rise to a preset temperature T_{S3} from T_{S2} and maintain at the temperature T_{S3}. The magnetic stirring apparatus 12 is started, to allow gas desorption endothermic reaction to extensively start. When the heating power of the main electric heaters H_{R} 7 is zero and the gas discharge flow is zero, the desorption reaction is judged as ending. The heat absorption amount Q of the desorption reaction is calculated according to the internal energy U change of the same reagents with experimental calibration in advance from reaction temperature T_{S2} to T_{S3} and the input thermal energy Q_{JOU} of the main electric heaters H_{R} 7:

Q_{JOU}=U_{TS3}−U_{TS2}+Q

What is claimed is:

1. A device for measuring gas chemical solvent absorption and desorption reaction heat, comprising:
an outer casing;
a metal guard inner shell;
a reactor provided in a middle portion of the metal guard inner shell;
a pressure sensor;
a thermal insulation material provided between the outer casing and the metal guard inner shell;
a group of guard electric heaters H_{GU} and a group of guard electric heaters H_{GL} provided respectively in an upper portion and a lower portion of an outer periphery of the metal guard inner shell;
a glass fiber thermal insulation layer provided between the metal guard inner shell and the reactor;
temperature thermocouples provided in the glass fiber thermal insulation layer;
a glass fiber board provided in a lower portion of an outer periphery of the reactor;
main electric heaters H_{R} provided between the glass fiber board and the reactor;
a magnetic stirring bar provided above a bottom portion of the reactor;
a magnetic stirring apparatus provided at an outer side of a bottom portion of the outer casing;
a liquid inlet pipe and a gas discharge pipe extending from an upper portion of the reactor toward a top portion of the outer casing;
a temperature thermistor and a liquid discharge pipe extending from above the bottom portion of the reactor toward the top portion of the outer casing;
a data acquisition board connected with signal wires of the pressure sensor, the temperature thermocouples inside the metal guard inner shell and outside the reactor in the glass fiber thermal insulation layer, the temperature thermistor extending into the reactor, and the temperature thermocouples in the glass fiber board;
a computer connected with the data acquisition board; and
a power supply connected with the guard electric heaters outside the metal guard inner shell and the main electric heaters H_{R} outside the reactor.

2. The device for measuring gas chemical solvent absorption and desorption reaction heat according to claim 1, wherein a gas inlet pipe is provided so that a segment of the gas inlet pipe outside the outer casing is provided with a ball valve and a self-operated pressure regulating valve is positioned in front of the ball valve.

3. The device for measuring gas chemical solvent absorption and desorption reaction heat according to claim 1, wherein a segment of the liquid inlet pipe outside the outer casing is provided with a right angle tee, a vertical segment of the right angle tee is provided with a liquid feeding port and a ball valve, a horizontal segment of the right angle tee is provided with a safety valve, a ball valve, a pressure gage and the pressure sensor.

4. The device for measuring gas chemical solvent absorption and desorption reaction heat according to claim 1, wherein a segment of the gas discharge pipe outside the outer casing is provided with a self-operated pressure regulating valve.

5. The device for measuring gas chemical solvent absorption and desorption reaction heat according to claim 1, wherein a segment of the liquid discharge pipe outside the outer casing is provided with a ball valve.

6. The device for measuring gas chemical solvent absorption and desorption reaction heat according to claim 1, wherein an area dividing line is defined between the guard electric heaters H_{GU} in the upper portion of the outer periphery of the metal guard inner shell and the guard electric heaters H_{GL} in the lower portion of the outer periphery of the metal guard inner shell, an area above the area dividing line is defined as a U area, an area below the area dividing line is defined as a L area.

7. A method for measuring gas chemical solvent absorption and desorption reaction heat, including steps of:
heating a sample solvent by main electric heaters H_{R} provided in a lower portion of an outer periphery of a reactor;
measuring temperatures of a wall of the reactor by groups of temperature thermocouples uniformly distributed at an outer side of the wall of the reactor, averaging the temperatures of the wall positioned in a lower portion area outside the reactor and inside the main electric heaters H_{R} measured by the temperature thermocouples as T_{WL}, averaging the temperatures of the wall positioned in an upper portion area of the reactor as T_{WU}, uniformly providing a group of temperature thermocouples at a distance of 1-5 mm from the outer side of the main electric heaters H_{R} and averaging temperatures measured by the group of temperature thermocouples as T_{IN}, filling a glass fiber board between the group of temperature thermocouples and the main electric heaters H_{R};
placing the assembly of the reactor and the main electric heaters H_{R} in a metal guard inner shell filled with a glass fiber thermal insulation layer;
providing an upper group of guard electric heaters H_{GU} and a lower group of guard electric heaters H_{GL} at positions on an outer surface of a wall of the metal guard inner shell corresponding to the main electric heaters H_{R} for the reactor, at the same time uniformly providing an upper group of temperature thermocouples and a lower group of temperature thermocouples at positions on an inner surface of the wall of the metal guard inner shell respectively corresponding to the upper group of guard electric heaters and the lower group of guard electric heaters, averaging temperatures measured by the upper group of temperature thermocouples as T_{GU} and averaging temperatures measured by the lower group of temperature thermocouples as T_{GL};
powering the main electric heaters H_{R} and the guard electric heaters H_{GU} and H_{GL} by a power supply, and measuring and adjusting heating powers of the main electric heaters and the guard electric heaters by a computer; and
placing the above assembly into an outer casing filled with a thermal insulation material, controlling that the temperature of the outer surface of the wall of the metal guard inner shell is equal to the temperature of the outer surface of the wall of the reactor or the temperature of the a glass fiber board outside the main electric heaters H_{R} with a program, maintaining an adiabatic condition of the reactor when the exothermic reaction occurs or endothermic reaction occurs and the main electric heaters H_{R} start in the experiment, and then calculating heat release amount or heat absorption amount of the reaction according to an internal energy change measured by experimental calibration and a Joule heat of the main electric heaters H_{R}.
